(19) United States
(12) Patent Application Publication
(10) Pub. No.: US 2025/0220478 A1
(43) Pub. Date: Jul. 3, 2025

(54) METHOD AND APPARATUS FOR DETERMINING CSI MEASUREMENT WINDOW AND CSI REPORTING WINDOW IN MOBILE COMMUNICATIONS

(71) Applicant: MEDIATEK INC., Hsinchu City (TW)

(72) Inventors: Chien-Yi WANG, Hsinchu City (TW); Jiann-Ching GUEY, Hsinchu City (TW)

(21) Appl. No.: 18/844,934

(22) PCT Filed: Jun. 6, 2023
(86) PCT No.: PCT/CN2023/098578

§ 371 Date: Sep. 6, 2024

Related U.S. Application Data
(60) Provisional application No. 63/349,175, filed on Jun. 6, 2022.

(51) Int. Cl. H04W 24/10

(52) U.S. Cl. CPC H04W 24/10

(57) ABSTRACT

Various solutions for determining channel state information (CSI) measurement window and CSI reporting window with respect to user equipment and network apparatus in mobile communications are described. An apparatus may transmit a user equipment (UE) capability parameter related to a maximum supportable time span of a CSI reporting window. The apparatus may receive a time span of a CSI reporting window configured according to the UE capability parameter.

### CROSS REFERENCE TO RELATED PATENT APPLICATION(S)

The present disclosure is part of a non-provisional application claiming the priority benefit of U.S. Patent Application No. 63/349,175, filed 6 Jun. 2022, the content of which herein being incorporated by reference in its entirety.

### TECHNICAL FIELD

The present disclosure is generally related to mobile communications and, more particularly, to channel state information (CSI) reporting with respect to user equipment (UE) and network apparatus in mobile communications.

### BACKGROUND

Unless otherwise indicated herein, approaches described in this section are not prior art to the claims listed below and are not admitted as prior art by inclusion in this section.

In conventional networks, the throughput between the user equipment (UE) and the network node (e.g., gNB) may significantly decrease in high/medium velocity movement scenarios. This is partly due to the reported channel state information (CSI) becoming outdated, as the channel undergoes fast variations during high/medium velocity movements.

To improve throughput, the network node needs to be aware of whether the CSI of the corresponding channel will be good enough in the near future. Therefore, CSI prediction is introduced as an extrapolation of CSI measurement. This is because obtaining future CSI with a single snapshot measurement may not be possible, and detecting any channel variation for prediction purposes requires at least two CSI measurements.

Accordingly, the configurations of the CSI measurement window (i.e., a time window includes all the CSI-RS transmission occasions used for CSI calculation) and the CSI reporting window (i.e., a time window includes all the slots or subperiods that the calculated CSI represents) are important, and there is a need to provide proper schemes to configure the CSI measurement window and the CSI reporting window.

### SUMMARY

The following summary is illustrative only and is not intended to be limiting in any way. That is, the following summary is provided to introduce concepts, highlights, benefits and advantages of the novel and non-obvious techniques described herein. Selected implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to determine the CSI measurement window and the CSI reporting window with respect to user equipment (UE) and network apparatus in mobile communications.

In one aspect, a method may involve an apparatus transmitting a UE capability parameter related to a maximum supportable time span of a CSI reporting window for the apparatus. The method may also involve the apparatus receiving a time span of a CSI reporting window configured according to the UE capability parameter.

In one aspect, a method may involve an apparatus receiving a UE capability parameter related to a maximum supportable time span of a CSI reporting window. The method may also involve the apparatus determining a time span of a CSI reporting window configured according to the UE capability parameter. The method may also involve the apparatus transmitting the time span of the CSI reporting window.

In one aspect, an apparatus may comprise a transceiver which, during operation, wirelessly communicates with at least one network node of a wireless network. The apparatus may also comprise a processor communicatively coupled to the transceiver. The processor, during operation, may perform operations comprising transmitting, via the transceiver, a UE capability parameter related to a maximum supportable time span of a CSI reporting window for the apparatus. The processor may also perform operations comprising receiving, via the transceiver, a time span of a CSI reporting window configured according to the UE capability parameter.

In one aspect, an apparatus may comprise a transceiver which, during operation, wirelessly communicates with at least one user equipment of a wireless network. The apparatus may also comprise a processor communicatively coupled to the transceiver. The processor, during operation, may perform operations comprising receiving, via the transceiver, a UE capability parameter related to a maximum supportable time span of a CSI reporting window. The processor may also perform operations comprising determining a time span of a CSI reporting window configured according to the UE capability parameter. The processor may also perform operations comprising transmitting, via the transceiver, the time span of the CSI reporting window.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3A is a diagram depicting example scenarios under schemes in accordance with implementations of the present disclosure.

FIG. 3B is a diagram depicting example scenarios under schemes in accordance with implementations of the present disclosure.

FIG. 3C is a diagram depicting example scenarios under schemes in accordance with implementations of the present disclosure.

FIG. 4 is a block diagram of an example communication system in accordance with an implementation of the present disclosure.

FIG. 5 is a flowchart of an example process in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to determine the CSI measurement window and the CSI reporting window with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

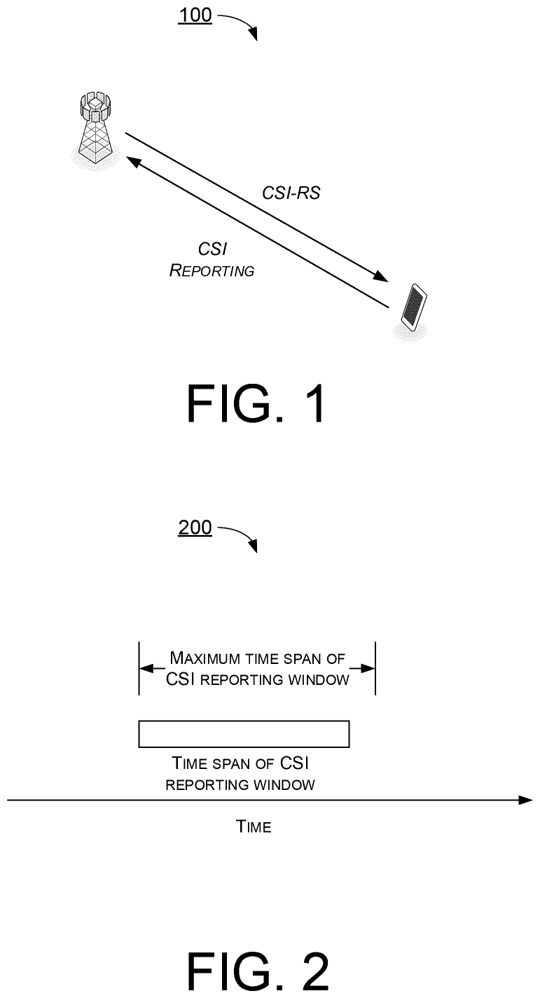

FIG. 1 illustrates an example scenario 100 under schemes in accordance with implementations of the present disclosure. Scenario 100 involves at least one network node and a UE, which may be a part of a wireless communication network (e.g., an LTE network, a 5G/NR network, an IoT network or a 6G network). Scenario 100 illustrates the current NR CSI framework.

The UE may connect to the network side. The network side may comprise one or more than one network nodes. The network node may transmit a CSI-RS to the UE. Each UE may acquire CSI between itself and the network node by measuring the CSI-RS and report CSI to the network node.

When there is a full overlap between the CSI reporting window and the CSI measurement window, the network node obtains past CSI representing past slots and predicts future CSI for future slots, which is network node-base prediction. When the CSI reporting window is after the CSI measurement window without overlap, prediction is carried out by the UE, which is UE-based prediction.

Time span of the CSI reporting window depends on the UE's processing and prediction capability. Regarding the network node-based prediction, a larger CSI reporting window requires the UE to process more CSI measurement instances to generate a CSI report. Regarding the UE-based prediction, a larger CSI reporting window requires the UE to make predictions further into the future, which is more challenging than predicting the near future. Therefore, the UE should be able to report a maximum time span of the CSI reporting window that the UE may support.

In some implementations, the UE reports a maximum supportable time span of the CSI reporting window by reporting UE capability. When the UE supports multiple reporting modes, the UE may report the UE capabilities separately for different modes. For example, when the UE supports both network-node-based prediction and UE-based prediction, two UE capabilities, which correspond two maximum time spans, are reported. One of the UE capabilities is for network node-based prediction, and the other is for UE-based prediction.

FIG. 2 illustrates an example scenario 200 under schemes in accordance with implementations of the present disclosure. Scenario 200 involves at least one network node and a UE, which may be a part of a wireless communication network (e.g., an LTE network, a 5G/NR network, an IoT network or a 6G network). Scenario 200 illustrates a maximum supportable time span of a CSI reporting window.

In particular, the network node receives a UE capability parameter, which is related to a maximum supportable time span of a CSI reporting window, from the UE and determines the maximum time span of the CSI reporting window according to the UE capability parameter. The maximum supportable time span is associated with a movement parameter, which may be transmitted form the network node to the UE, for configuring the time span of the CSI reporting window. For example, the movement parameter includes a velocity, a Doppler shift or a Doppler spread related to movement of the UE.

In some implementations, the maximum supportable time span of the CSI reporting window is determined based on following formula:

$${W}_{repo , derived}^{′} = {W}_{repo , baseline} \times \frac{{p}_{baseline}}{p}$$

while W′_{repo,derived} is the maximum supportable time span of the CSI reporting window, W_{repo,baseline} is a pre-determined window size associated with the movement parameter, and p_{baseline} is the UE capability parameter and p is a dynamic value associated with the movement parameter.

In some implementations, before determining the maximum supportable time span of the CSI reporting window, the network node detects a UE state, which is associated with the movement parameter, of the UE, and determines the dynamic value p associated with the movement parameter according to the detected UE state.

For example, the maximum supportable time span is associated with velocity of the UE. The UE reports the UE capability parameter “1”. After receiving the UE capability parameter, the network node: (1) detects the UE state, which is velocity 60 km/hr, of the UE, (2) determines the dynamic value p as “2” based on the detected velocity 60 km/hr of the UE, and (3) determines the maximum supportable time span of the CSI measurement window W′_{repo,derived} as half of the pre-determined window size W_{repo,baseline} based on the above formula. It should be noted that the mapping between the value “2” for the dynamic value p and the velocity of 60 km/hr, as well as the pre-determined window size W_{repo,baseline}, are both pre-configured in the network via radio resource control (RRC) configuration transmitted between the network node and the UE.

Time span of the CSI measurement window affects the resolution in the Doppler domain. A longer time span leads to higher resolution, so a larger CSI measurement window is preferable. The number of CSI-RS transmission occasions required is up to the UE implementation, but a minimum time span of the CSI measurement window needs to be specified because the UE may be forced to report unreliable CSI without the minimum time span of the CSI measurement window.

Failure to meet the minimum time span of the CSI measurement window may be due to: (1) just after configuration or activation; (2) CSI-RS transmission occasion(s) is/are not actually transmitted. When the minimum time span of the CSI measurement window cannot be met, the UE may drop the CSI report or still report the CSI in a reduced time span of the CSI reporting window.

In some implementations, the minimum time span of the CSI measurement window is pre-configured in the network via RRC configuration transmitted between the network node and the UE. When the UE determines an actual time span of the CSI measurement window and the actual time span of the CSI measurement is less than the minimum time span of CSI measurement window (i.e., the actual time span of the CSI measurement does not meet the minimum time span of the CSI measurement window), the UE calculates the reduced time span of the CSI reporting window, and transmits a parameter related to the reduced time span of the CSI reporting window to the network node. The reduced time span of the CSI reporting window is less than the configured time span of CSI reporting window. Then, the UE transmits at least one CSI report to the network node for the reduced CSI reporting window. The network node receives the at least one CSI report.

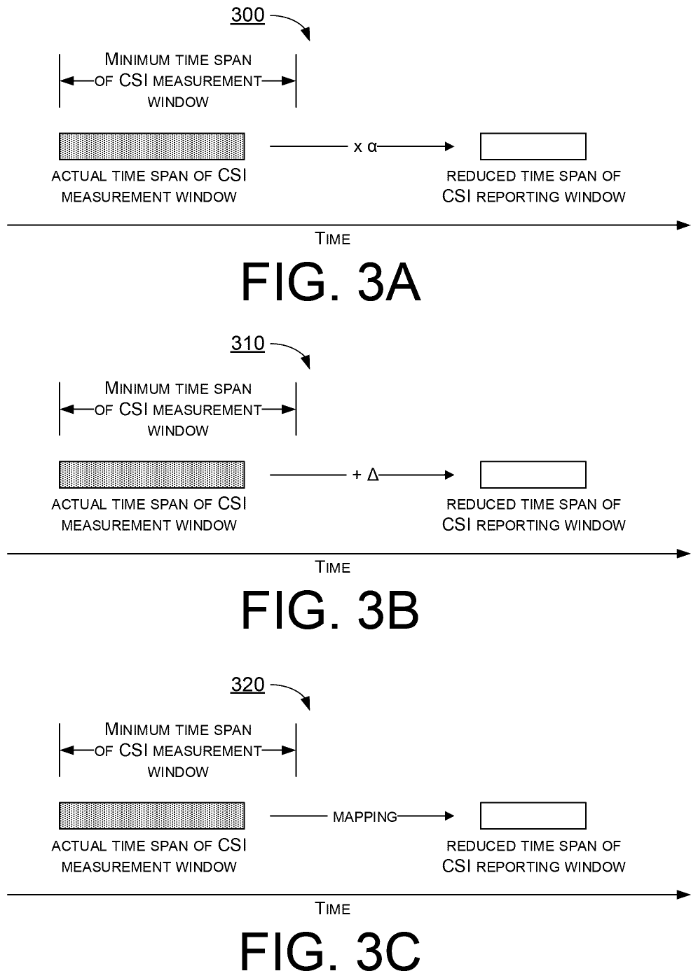

FIGS. 3A to 3C illustrate example scenarios 300 to 320 under schemes in accordance with implementations of the present disclosure. Scenarios 300 to 320 respectively involve at least one network node and the UE, which may be a part of a wireless communication network (e.g., an LTE network, a 5G/NR network, an IoT network or a 6G network). Scenarios 300 to 320 illustrates relations between the actual time span of the CSI measurement and the reduced time span of the CSI reporting window when the actual time span of the CSI measurement does not meet the minimum time span of the CSI measurement window.

In some implementations, as shown in FIG. 3A, the reduced CSI reporting window is determined as a product of a ratio and the actual time span of the CSI measurement window. For example, the ratio is a fixed or Doppler(speed)-dependent ratio α and the actual time span of the CSI measurement window is W′ₘₑₐₛ. Therefore, the reduced CSI reporting window W′ᵣₑₚₒ is calculated as: W′ᵣₑₚₒ=αW′ₘₑₐₛ.

In some implementations, as shown in FIG. 3B, the reduced CSI reporting window is determined as a sum of an offset and the actual time span of the CSI measurement window. For example, the offset is a fixed or Doppler(speed)-dependent offset Δ, and the actual time span of the CSI measurement window is W′ₘₑₐₛ. Therefore, the reduced CSI reporting window W′ᵣₑₚₒ is calculated as: W′ᵣₑₚₒ=W′ₘₑₐₛ+Δ.

In some implementations, as shown in FIG. 3C, the reduced CSI reporting window is determined as a specified CSI reporting window mapping to a level of the actual time span of the CSI measurement window. In particular, different levels of the actual time span of the CSI measurement window are mapped to different time spans of the CSI reporting window. For example, the actual time span of the CSI measurement window is W′ₘₑₐₛ and W′ₘₑₐₛ is at level one which maps to the reduced CSI reporting window W′ᵣₑₚₒ. Therefore, the reduced CSI reporting window W′ᵣₑₚₒ is determined by the mapping relation.

The time gap between CSI measurement instances or CSI-RS transmission occasions affects the maximum observable Doppler shifts, with a shorter time gap being required for the UE with high velocity. However, not all UEs can handle very short time gaps, such as those without pipelined processing. In these cases, the time gap should be large enough to allow the UEs to complete CSI processing (or pre-processing) before the arrival of the next CSI-RS. Accordingly, another UE capability parameter is introduced to specify a minimum supported time gap for CSI measurement instances.

In some implementations, the UE transmits another UE capability parameter to the network node. The network node receives the another UE capability parameter. In particular, in these implementations, the another UE capability parameter indicates the network node whether a size of subperiod less than a time gap of CSI measurement instance is supported by the UE. In other words, via the another UE capability parameter, the UE can indicate the network node that whether the UE supports the scenario of the size of subperiod being less than a time gap of CSI measurement instance.

It should be noted that the CSI reporting window may be defined as a time window including all the slots or subperiods that the calculated CSI represents, where a subperiod consists of multiple consecutive slots. When a CSI represents a certain slot or subperiod, it means the CSI can be directly used in this slot or subperiod without the need to consider other CSI. A CSI reporting instance corresponds to a slot or a subperiod, where UE calculates a CSI for the channel instance(s) associated with that slot or subperiod.

In some implementations, the UE transmits another UE capability parameter to the network node indicating which time gap a CSI measurement window and the CSI reporting window is supported. In particular, in these implementations, to ensure reliable extrapolation performance, a time gap between the CSI measurement window and the CSI reporting window should fall within a certain range when performing UE-based prediction. When the first CSI reporting instance in the CSI reporting window is too distant from the latest available CSI measurement instance in the CSI measurement window, the prediction accuracy may be too low to warrant reporting. Accordingly, to prevent this, the maximum time gap between the CSI measurement window and the CSI reporting window should be specified. When the time gap between the CSI measurement window and the CSI reporting window exceeds the maximum time gap, the CSI report is either dropped or calculated using the legacy snap-shot CSI reporting.

In some implementations, the UE transmits another UE capability parameter to the network node. The network node receives the another UE capability parameter from the UE. The another UE capability parameter indicates the network node a maximum tolerable time gap of two available CSI measurement instances. In these implementations, even if the default time gap between two CSI measurement instances is the same as the default time gap between two CSI reporting instances, the UE may still need to perform interpolation in case the network node cannot transmit the CSI-RS in certain slots (e.g., uplink slots). The quality of interpolation depends on the time gap of two available CSI measurement instances, i.e., the quality of interpolation depends on the time gap of two actually received CSI measurement instances. When the actual time gap is large, then the interpolated CSI measurement instances may deviate from the actual ones. To address this issue, the another UE capability parameter is introduced, allowing the UE to report the maximum tolerable time gap of two available CSI measurement instances. When the UE capability parameter cannot be met, the UE either drops the CSI report or falls back to the legacy snap-shot CSI reporting.

In some implementations, the UE transmits a CSI fallback indicator to the network node. The network node receives the CSI fallback indicator from the UE. The CSI fallback indicator indicates the network node a CSI reporting mode the UE needs to fall back to. In these implementations, when some mentioned conditions cannot be satisfied, the CSI report can fall back to one of the legacy CSI reporting modes. Since the network node is aware of the unavailability of CSI measurement instances, the network node knows the CSI report is a fallback one or not. However, there may be situations where channel conditions change abruptly and the prediction/extrapolation accuracy becomes uncontrollable. In such cases, it is preferable to report robust CSI with less feedback overhead rather than highly inaccurate CSI. The saved feedback overhead can then be utilized to transmit uplink data.

To address this, the CSI fallback indicator is introduced to CSI consisting of two parts. The CSI fallback indicator indicates the network node whether the reported CSI is a fallback one or not. The CSI fallback indicator is transmitted on a first part of CSI, which is of fixed size. A second part of CSI is of variable size, as its payload size depends on the CSI fallback indicator, of CSI.

For example, the CSI fallback indicator consists of one bit, with the value “1” indicates fallback. There are various options for the fallback mode such as (a) fallback to Type I single-panel codebook, (b) fallback to a Type II codebook, (c) same reporting format except the number of ports is reduced.

For example, the CSI fallback consists of multiple bits, such as two bits which can used to indicate four codepoints. One codepoint is to signal non-fallback, whereas other codepoints are used to signal a distinct fallback mode. The fallback modes can be configured by RRC configuration transmitted from the network node.

### Illustrative Implementations

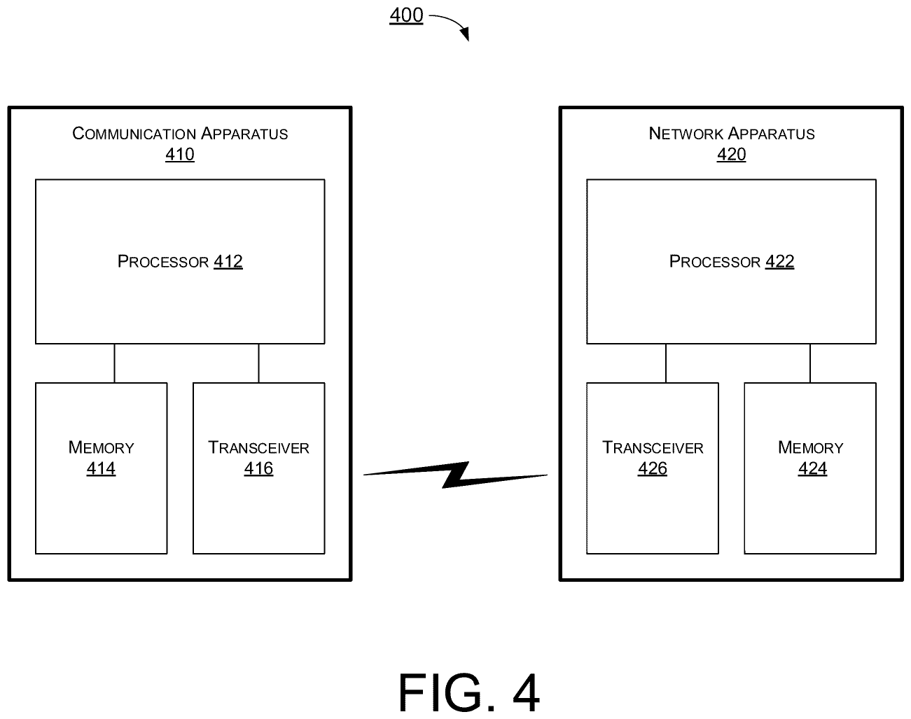

FIG. 4 illustrates an example communication system 400 having an example communication apparatus 410 and an example network apparatus 420 in accordance with an implementation of the present disclosure. Each of communication apparatus 410 and network apparatus 420 may perform various functions to implement schemes, techniques, processes and methods described herein pertaining to determine the CSI measurement window and the CSI reporting window with respect to UE and network apparatus in mobile communications, including scenarios/schemes described above as well as process 500 described below.

Communication apparatus 410 may be a part of an electronic apparatus, which may be a UE such as a portable or mobile apparatus, a wearable apparatus, a wireless communication apparatus or a computing apparatus. For instance, communication apparatus 410 may be implemented in a smartphone, a smartwatch, a personal digital assistant, a digital camera, or a computing equipment such as a tablet computer, a laptop computer or a notebook computer. Communication apparatus 410 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 410 may be implemented in a smart thermostat, a smart fridge, a smart door lock, a wireless speaker or a home control center. Alternatively, communication apparatus 410 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 410 may include at least some of those components shown in FIG. 4 such as a processor 412, for example. Communication apparatus 410 may further include one or more other components not pertinent to the proposed scheme of the present disclosure (e.g., internal power supply, display device and/or user interface device), and, thus, such component(s) of communication apparatus 410 are neither shown in FIG. 4 nor described below in the interest of simplicity and brevity.

Network apparatus 420 may be a part of a network apparatus, which may be a network node such as a satellite, a base station, a small cell, a router or a gateway. For instance, network apparatus 420 may be implemented in an eNodeB in an LTE network, in a gNB in a 5G/NR, IoT, NB-IoT or IIoT network or in a satellite or base station in a 6G network. Alternatively, network apparatus 420 may be implemented in the form of one or more IC chips such as, for example and without limitation, one or more single-core processors, one or more multi-core processors, or one or more RISC or CISC processors. Network apparatus 420 may include at least some of those components shown in FIG. 4 such as a processor 422, for example. Network apparatus 420 may further include one or more other components not pertinent to the proposed scheme of the present disclosure (e.g., internal power supply, display device and/or user interface device), and, thus, such component(s) of network apparatus 420 are neither shown in FIG. 4 nor described below in the interest of simplicity and brevity.

In one aspect, each of processor 412 and processor 422 may be implemented in the form of one or more single-core processors, one or more multi-core processors, or one or more CISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks including autonomous reliability enhancements in a device (e.g., as represented by communication apparatus 410) and a network (e.g., as represented by network apparatus 420) in accordance with various implementations of the present disclosure.

In some implementations, communication apparatus 410 may also include a transceiver 416 coupled to processor 412 and capable of wirelessly transmitting and receiving data. In some implementations, communication apparatus 410 may further include a memory 414 coupled to processor 412 and capable of being accessed by processor 412 and storing data therein. In some implementations, network apparatus 420 may also include a transceiver 426 coupled to processor 422 and capable of wirelessly transmitting and receiving data. In some implementations, network apparatus 420 may further include a memory 424 coupled to processor 422 and capable of being accessed by processor 422 and storing data therein. Accordingly, communication apparatus 410 and network apparatus 420 may wirelessly communicate with each other via transceiver 416 and transceiver 426, respectively. To aid better understanding, the following description of the operations, functionalities and capabilities of each of communication apparatus 410 and network apparatus 420 is provided in the context of a mobile communication environment in which communication apparatus 410 is implemented in or as a communication apparatus or a UE and network apparatus 420 is implemented in or as a network node of a communication network.

In some implementations, processor 412 may transmit, via the transceiver 416, a UE capability parameter. The UE capability parameter is related to a maximum supportable time span of a CSI reporting window. Processor 412 may receive a time span of a CSI reporting window configured according to the UE capability parameter.

In some implementations, processor 422 may receive, via the transceiver 426, a UE capability parameter. Processor 422 may determine a maximum supportable time span of a CSI reporting window according to the UE capability parameter. Processor 422 may transmit, via the transceiver 426, the time span of the CSI reporting window.

In some implementations, processor 412 may transmit, via the transceiver 416, a movement parameter for configuring the time span of the CSI reporting window.

In some implementations, processor 422 may receive, via the transceiver 426, a movement parameter for configuring the time span of the CSI reporting window.

In some implementations, the movement parameter includes a velocity, a Doppler shift or a Doppler spread.

In some implementations, the maximum time span of the CSI reporting window is determined based on following formula:

$${W}_{repo , derived}^{′} = {W}_{repo , baseline} \times \frac{{p}_{baseline}}{p}$$

while W′_{repo,derived} is the maximum time span of the CSI reporting window, W_{repo,baseline} is a pre-determined window size associated with the movement parameter, and p_{baseline} is the UE capability parameter and p is a dynamic value associated with the movement parameter.

In some implementations, processor 422 may detect a UE state associated with the movement parameter, and processor 422 determines the dynamic value associated with the movement parameter according to the detected UE state.

In some implementations, processor 412 may transmit, via the transceiver 416, a parameter related to a reduced time span of a CSI reporting window. The reduced time span of the CSI reporting window is less than the configured time span of CSI reporting window. Processor 412 may transmit, via the transceiver 416, at least one CSI report for the reduced time span of CSI reporting window.

In some implementations, processor 422 may receive, via the transceiver 426, a parameter related to a reduced time span of a CSI reporting window. The reduced time span of the CSI reporting window is less than the configured time span of CSI reporting window. Processor 422 may receive, via the transceiver 426, at least one CSI report for the reduced time span of CSI reporting window.

In some implementations, the reduced CSI reporting window is determined as a product of a ratio and the actual time span of the CSI measurement window, a sum of an offset and the actual time span of the CSI measurement window or a specified CSI reporting window mapping to a level of the actual time span of the CSI measurement window.

In some implementations, processor 412 may transmit, via transceiver 416, another UE capability parameter indicating whether a size of subperiod less than a time gap of CSI measurement instance is supported.

In some implementations, processor 422 may receive, via transceiver 426, another UE capability parameter indicating whether a size of subperiod less than a time gap of CSI measurement instance is supported.

In some implementations, processor 412 may transmit, via the transceiver 416, another UE capability parameter indicating which time gap between a CSI measurement window and the CSI reporting window is supported.

In some implementations, processor 422 may receive, via transceiver 426, another UE capability parameter indicating which time gap between a CSI measurement window and the CSI reporting window is supported.

In some implementations, processor 412 may transmit, via transceiver 416, a CSI fallback indicator indicating a CSI reporting mode.

In some implementations, processor 422 may receive, via transceiver 426, a CSI fallback indicator indicating a CSI reporting mode.

### Illustrative Processes

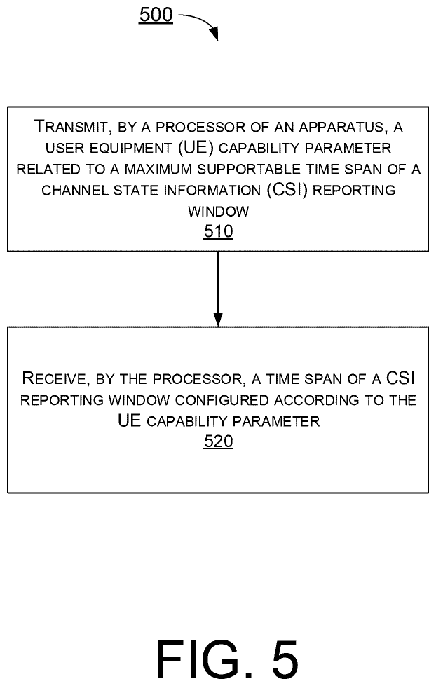

FIG. 5 illustrates an example process 500 in accordance with an implementation of the present disclosure. Process 500 may be an example implementation of above scenarios/schemes, whether partially or completely, with respect to determine CSI measurement window and CSI reporting window with the present disclosure. Process 500 may represent an aspect of implementation of features of communication apparatus 410. Process 500 may include one or more operations, actions, or functions as illustrated by one or more of blocks 510 and 520. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by network apparatus 420 or any suitable network nodes or machine type devices. Solely for illustrative purposes and without limitation, process 500 is described below in the context of network apparatus 420. Process 500 may begin at block 510.

At 510, process 500 may involve processor 412 of network apparatus 410 transmitting a UE capability parameter related to a maximum supportable time span of a CSI reporting window. Process 500 may proceed from 510 to 520.

At 520, process 500 may involve processor 412 receiving a time span of a CSI reporting window configured according to the UE capability parameter.

In some implementations, process 500 may further involve processor 412 transmitting a movement parameter for configuring the time span of the CSI reporting window.

In some implementations, process 500 may further involve processor 412 transmitting a parameter related to a reduced time span of a CSI reporting window. The reduced time span of the CSI reporting window is less than the configured time span of CSI reporting window. process 500 may further involve processor 412 transmitting at least one CSI report for the reduced time span of CSI reporting window.

In some implementations, process 500 may further involve processor 412 transmitting another UE capability parameter indicating whether a size of subperiod less than a time gap of CSI measurement instance is supported.

In some implementations, process 500 may further involve processor 412 transmitting another UE capability parameter indicating which time gap between a CSI measurement window and the CSI reporting window is supported.

In some implementations, process 500 may further involve processor 412 transmitting another UE capability parameter indicating a maximum tolerable time gap of two available CSI measurement instances.

In some implementations, process 500 may further involve processor 412 transmitting a CSI fallback indicator indicating a CSI reporting mode.

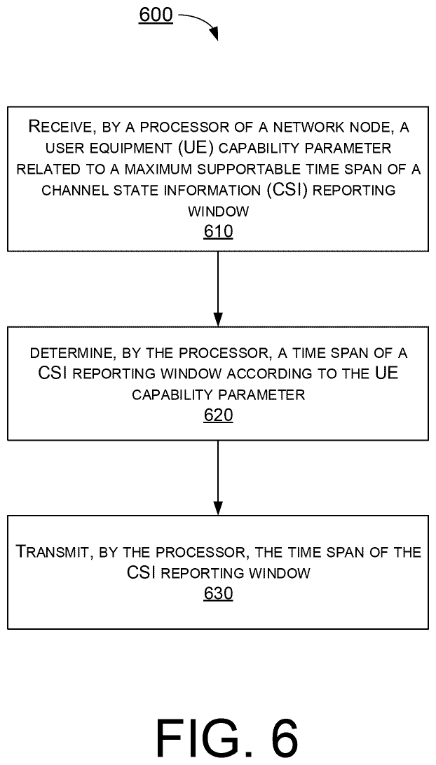

FIG. 6 illustrates an example process 600 in accordance with an implementation of the present disclosure. Process 600 may be an example implementation of above scenarios/schemes, whether partially or completely, with respect to determine CSI measurement window and CSI reporting window with the present disclosure. Process 600 may represent an aspect of implementation of features of network apparatus 420. Process 600 may include one or more operations, actions, or functions as illustrated by one or more of blocks 610, 620 and 630. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by network apparatus 420 or any suitable network nodes or machine type devices. Solely for illustrative purposes and without limitation, process 600 is described below in the context of network apparatus 420. Process 600 may begin at block 610.

At 610, process 600 may involve processor 422 of network apparatus 420 receiving a UE capability parameter related to a maximum supportable time span of a CSI reporting window. Process 600 may proceed from 610 to 620.

At 620, process 600 may involve processor 422 determining a time span of a CSI reporting window according to the UE capability parameter. Process 600 may proceed from 620 to 630.

At 630, process 600 may involve processor 422 transmitting the time span of the CSI reporting window.

In some implementations, process 600 may further involve processor 422 receiving a movement parameter for configuring the time span of the CSI reporting window.

In some implementations, process 600 may further involve processor 422 receiving a parameter related to a reduced time span of a CSI reporting window. The reduced time span of the CSI reporting window is less than the configured time span of CSI reporting window. Process 600 may further involve processor 422 receiving at least one CSI report for the reduced time span of CSI reporting window.

In some implementations, process 600 may further involve processor 422 receiving another UE capability parameter indicating whether a size of subperiod less than a time gap of CSI measurement instance is supported.

In some implementations, process 600 may further involve processor 422 receiving another UE capability parameter indicating which time gap between a CSI measurement window and the CSI reporting window is supported.

In some implementations, process 600 may further involve processor 422 receiving another UE capability parameter indicating a maximum tolerable time gap of two available CSI measurement instances.

In some implementations, process 600 may further involve processor 422 receiving a CSI fallback indicator indicating a CSI reporting mode.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
transmitting, by a processor of an apparatus, a user equipment (UE) capability parameter related to a maximum supportable time span of a channel state information (CSI) reporting window for the apparatus; and
receiving, by the processor, a time span of a CSI reporting window configured according to the UE capability parameter.

2. The method of claim 1, further comprising:
transmitting, by the processor, a movement parameter for configuring the time span of the CSI reporting window.

3. The method of claim 2, wherein the movement parameter includes a velocity, a Doppler shift or a Doppler spread.

4. The method of claim 1, further comprising:
transmitting, by the processor, a parameter related to a reduced time span of a CSI reporting window, wherein the reduced time span of the CSI reporting window is less than the configured time span of CSI reporting window; and
transmitting, by the processor, at least one CSI report for the reduced time span of CSI reporting window.

5. The method of claim 1, further comprising:
transmitting, by the processor, another UE capability parameter indicating whether a size of subperiod less than a time gap of CSI measurement instance is supported.

6. The method of claim 1, further comprising:
transmitting, by the processor, another UE capability parameter indicating which time gap between a CSI measurement window and the CSI reporting window is supported.

7. The method of claim 1, further comprising:
transmitting, by the processor, another UE capability parameter indicating a maximum tolerable time gap of two available CSI measurement instances.

8. The method of claim 1, further comprising:
transmitting, by the processor, a CSI fallback indicator indicating a CSI reporting mode.

9. A method, comprising:
receiving, by a processor of a network node, a user equipment (UE) capability parameter related to a maximum supportable time span of a channel state information (CSI) reporting window;
determining, by the processor, a time span of a CSI reporting window according to the UE capability parameter; and
transmitting, by the processor, the time span of the CSI reporting window.

10. The method of claim 9, further comprising:
receiving, by the processor, a parameter related to a reduced time span of a CSI reporting window, wherein the reduced time span of the CSI reporting window is less than the configured time span of CSI reporting window; and
receiving, by the processor, at least one CSI report for the reduced time span of CSI reporting window.

11. The method of claim 9, further comprising:
receiving, by the processor, another UE capability parameter indicating which time gap between a CSI measurement window and the CSI reporting window is supported.

12. The method of claim 9, further comprising:
receiving, by the processor, another UE capability parameter indicating a maximum tolerable time gap of two available CSI measurement instances.

13. An apparatus, comprising:
a transceiver which, during operation, wirelessly communicates with at least one network node of a wireless network; and
a processor communicatively coupled to the transceiver such that, during operation, the processor performs operations comprising:
transmitting, via the transceiver, a user equipment (UE) capability parameter related to a maximum supportable time span of a channel state information (CSI) reporting window for the apparatus; and
receiving, via the transceiver, a time span of a CSI reporting window configured according to the UE capability parameter.

14. The apparatus of claim 13, wherein, during operation, the processor further performs operations comprising:
transmitting, via the transceiver, a movement parameter for configuring the time span of the CSI reporting window.

15. The apparatus of claim 13, wherein the movement parameter includes a velocity, a Doppler shift or a Doppler spread.

16. The apparatus of claim 13, wherein, during operation, the processor further performs operations comprising:
transmitting, via the transceiver, a parameter related to a reduced time span of a CSI reporting window, wherein the reduced time span of the CSI reporting window is less than the configured time span of CSI reporting window; and
transmitting, via the transceiver, at least one CSI report for the reduced time span of CSI reporting window.

17. The apparatus of claim 13, wherein, during operation, the processor further performs operations comprising:
transmitting, via the transceiver, another UE capability parameter indicating whether a size of subperiod less than a time gap of CSI measurement instance is supported.

18. The apparatus of claim 13, wherein, during operation, the processor further performs operations comprising:
transmitting, via the transceiver, another UE capability parameter indicating which time gap between a CSI measurement window and the CSI reporting window is supported.

19. The apparatus of claim 13, wherein, during operation, the processor further performs operations comprising:
transmitting, via the transceiver, another UE capability parameter indicating a maximum tolerable time gap of two available CSI measurement instances.

20. The apparatus of claim 13, wherein, during operation, the processor further performs operations comprising:
transmitting, via the transceiver, a CSI fallback indicator indicating a CSI reporting mode.
